(19) United States
(12) Patent Application Publication
(10) Pub. No.: US 2006/0254541 A1
(43) Pub. Date: Nov. 16, 2006

(54) Breather for a pump

(76) Inventors: Peter Nushart, Waukesha, WI (US); Wesley C. Sodemann, Dousman, WI (US); Christopher Ludlum, Beloit, WI (US); Billy Brandenburg, Horicon, WI (US)

Correspondence Address: MICHAEL BEST & FRIEDRICH, LLP, 100 E WISCONSIN AVENUE, MILWAUKEE, WI, 53202, US

(21) Appl. No.: 11/418,223

(22) Filed: May 4, 2006

Related U.S. Application Data
(60) Provisional application No. 60/679,311, filed on May 10, 2005.

(51) Int. Cl. F01M 13/00; F15B 21/04

(52) U.S. Cl. 123/41.86; 92/82

(57) ABSTRACT

A breather assembly for a crankcase includes a chamber having a chamber pressure. The breather assembly includes a base coupled to the crankcase and having an interior. The base defines a first aperture to allow fluid communication between the chamber and the interior, and a second aperture to allow fluid communication between an atmosphere and the interior. A a movable membrane is disposed substantially within the interior to define a crankcase-side of the interior and an atmosphere-side of the interior.

### RELATED APPLICATION

This application claims priority to co-pending U.S. Provisional Application No. 60/679,311 filed on May 10, 2005 and fully incorporated herein by reference.

### BACKGROUND

The present invention relates to a breather assembly for a casing. More particularly, the present invention relates to a breather assembly for a piston housing that inhibits air exchange between the atmosphere and the piston housing.

During operation of a pump, or engine, pressure variations within the piston housing or crankcase often arise. These pressure variations can produce inefficiencies or other operational problems within the pump or engine. To accommodate these pressure changes, piston housings, or crankcases, are often fitted with a breather assembly. In most cases the breather assembly includes a filter that removes dirt or other debris from the air being drawn into the piston housing and filters oil, debris, or other contaminants from the air that is being discharged.

Without the filter, dirt or debris could be drawn into the engine or pump and could contaminate the oil and cause damage to the moving components of the pump or engine. Thus, the filter must be maintained and cleaned periodically.

Piston housings are often shipped to users with lubricant in the piston housing. As such, it is generally necessary to plug the breather opening provided in the piston housing to inhibit leakage of lubricant during shipping. The user is then required to remove the plug and install the breather before the pump can be used.

### SUMMARY

The invention provides a breather assembly that maintains the pressure within a piston housing or crankcase at a pressure that is substantially within a suitable range. The breather inhibits air exchange between the interior of the piston housing or crankcase and the atmosphere. The breather assembly varies the volume of the piston housing or crankcase to maintain the pressure therein.

In one embodiment the invention provides a breather assembly for a crankcase including a chamber having a chamber pressure. The breather assembly includes a base coupled to the crankcase and having an interior. The base defines a first aperture to allow fluid communication between the chamber and the interior, and a second aperture to allow fluid communication between an atmosphere and the interior. A a movable membrane is disposed substantially within the interior to define a crankcase-side of the interior and an atmosphere-side of the interior.

In another embodiment the invention provides a breather assembly for a crankcase including a chamber having a chamber pressure. The breather assembly includes a base coupled to the crankcase and including an interior. The base defines a first aperture to allow fluid communication between the crankcase and the interior. A cover is coupled to the base and includes a second aperture that provides fluid communication between an atmosphere and the interior. A movable membrane is disposed substantially within the interior to define a crankcase-side of the interior and an atmosphere-side of the interior.

### BRIEF DESCRIPTION OF THE DRAWINGS

FIG. 1 is a perspective view of a pump including a breather embodying the invention;

FIG. 2 is a section view of the pump of FIG. 1 taken along line 2-2 of FIG. 1;

FIG. 3 is a perspective view of a cap illustrating an outer surface;

FIG. 4 is a perspective view of the cap of FIG. 3 illustrating an inner surface;

FIG. 5 is a perspective view of the breather of FIG. 1 with the cap of FIGS. 3 and 4 removed;

FIG. 6 is a section view of the breather of FIG. 5 taken along line 6-6 of FIG. 5; and

FIG. 7 is an enlarged view of a joint of the breather of FIG. 6.

### DETAILED DESCRIPTION

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings. Further, “connected” and “coupled” are not restricted to physical or mechanical connections or couplings.

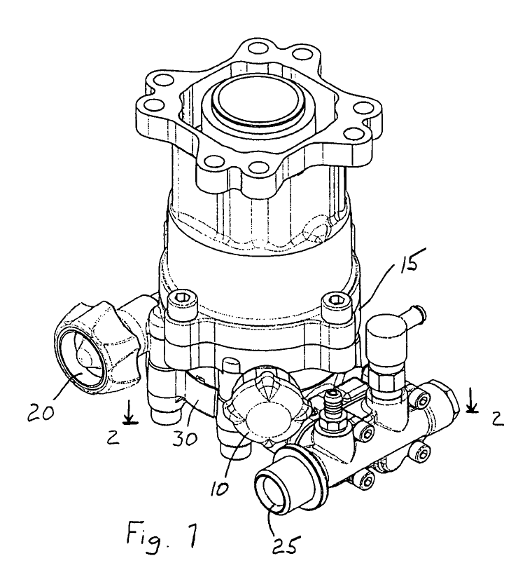

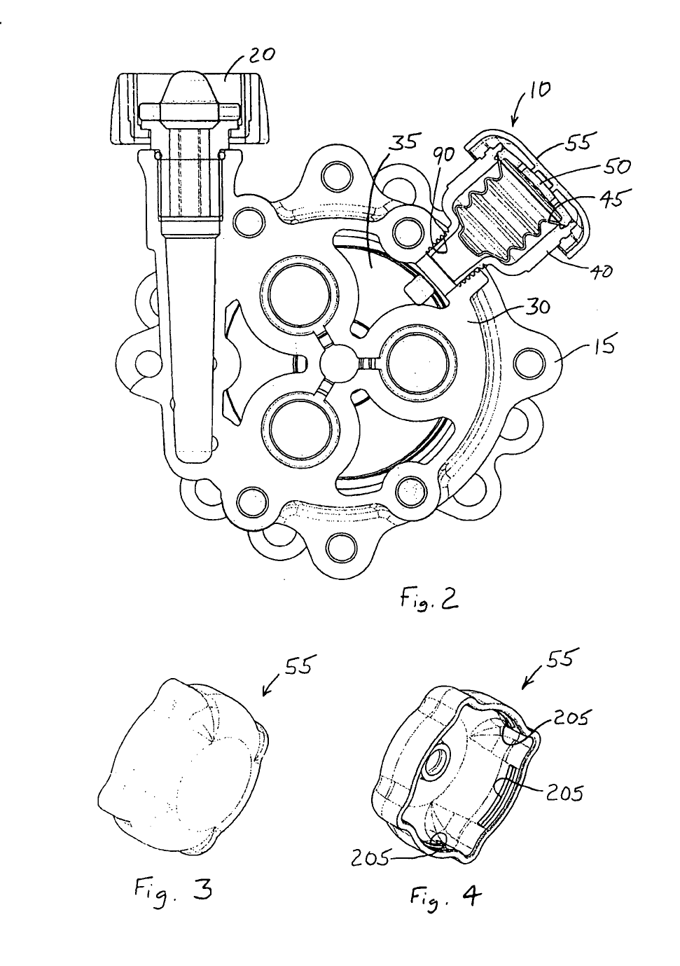

FIGS. 1 and 2 illustrate a breather assembly 10 coupled to a pump 15. The pump 15 includes an inlet 20 where fluid to be pumped is drawn into the pump 15 and an outlet 25 where pumped fluid is discharged. The pump 15 also includes a piston housing 30 that contains at least a portion of the moving parts of the pump 15 and at least partially defines a portion of the inlet 20, an engine adapter 31, a manifold 32 that at least partially defines the outlet 25, and a head 33. The piston housing 30 also defines a chamber 35 that serves as a reservoir for any lubricating fluid (e.g., lubricating oil) that may be used by the pump 15 to lubricate and cool moving parts. Of course other pumps may include fewer or additional parts as may be required by the particular application. The actual construction of the pump does not significantly affect the function of the invention described herein.

Before proceeding, it should be noted that while the breather assembly 10 has been described attached to a pump 15, it should be understood that the breather assembly 10 could also be attached to an engine crankcase. Furthermore, as one of ordinary skill will realize, the breather assembly 10 described herein could be used in many other applications where it is desirable to maintain a pressure within a substantially enclosed chamber or space with a variable volume or temperature. As such, while the invention is best suited to use with a positive displacement pump or piston engine, the invention should not be limited to these uses.

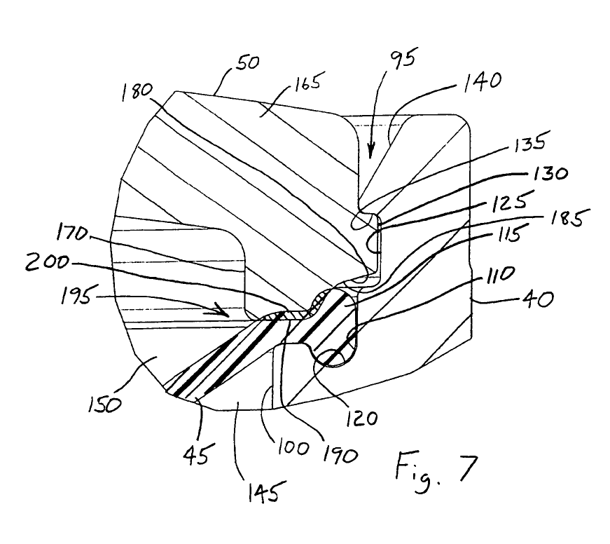

As illustrated in FIG. 2, the breather assembly 10 is attached to the piston housing 30 such that it is in fluid communication with the chamber 35. The breather assembly 10 includes a base 40, a bellows 45, a cover 50, and a cap 55. The base 40, best illustrated in FIG. 6, includes an attachment portion 60 and a body portion 65 that together define an interior 70. A first aperture 75 is formed near the end of the attachment portion 60 with a center disposed substantially along a central axis 80 of the base 40. The first aperture 75 provides fluid communication between the chamber 35 and the interior 70. The attachment portion 60 includes threads 85 that engage a threaded aperture 90 in the piston housing 30. Generally, standard pipe threads are employed to provide an adequate seal between the piston housing 30 and the attachment portion 60. Of course, other engagement means could be employed to attach the breather assembly 10 to the piston housing 30. For example, a quick disconnect could be employed. The quick disconnect would provide the necessary seal, and would allow for the easy removal of the breather assembly 10 from the piston housing 30. In yet another construction, standard threads are employed with an O-ring or other sealing mechanism (e.g., gasket) that assures an adequate seal between the piston housing 30 and the breather assembly 10.

The body portion 65 defines most of the interior 70 such that the interior 70 provides the necessary space for the bellows 45. The interior 70 is sized to define a sufficient volume to allow the breather assembly 10 to function properly under the expected operating conditions of the pump 15 (or other component to which the breather assembly 10 is attached). A seal portion 95 is formed at the end of the body portion 65 opposite the attachment portion 60. The seal portion 95 extends around a perimeter 100 that defines a second aperture 105 opposite the first aperture 75. The second aperture 105 is larger than the first aperture 75 with a center located substantially along the central axis 80 of the base 40.

Turning to FIG. 7, the seal portion 95 is shown enlarged to better illustrate the features. The seal portion 95 includes a bellows groove 110 that is shaped to receive a bellows tongue 115. In the illustrated construction, the bellows groove 110 includes an arcuate slot 120 that extends around the central axis 80 and a substantially planar surface 121. Of course other constructions may include bellows grooves 110 having various shapes including, but not limited to, square, rectangular, L-shaped, and the like.

The seal portion 95 also includes a cover slot 125 disposed above the bellows groove 110 (i.e., opposite the attachment portion 60). The cover slot 125 extends around the central axis 80 and is sized to receive a cover lip 130. The cover slot 125 defines a shoulder 135 that is substantially planar and is normal to the central axis 80. The shoulder 135 is spaced a predetermined distance from the bottom of the arcuate slot 120 and the surface 121. A tapered surface 140 is disposed immediately above the cover slot 125 (i.e., opposite the attachment portion 60) to facilitate assembly as will be described.

Returning to FIG. 6, the illustrated bellows 45 is a substantially air-impermeable membrane that is both flexible and resilient (e.g., rubber). The bellows 45 is positioned within the interior 70 to separate the interior. 70 into a crankcase-side or pump-side interior 145 and an atmosphere-side interior 150. The bellows 45 includes an open portion 155 disposed at the bellows top, and several pleats 160 that improve the flexibility of the bellows 45. The bellows tongue 115 extends around a perimeter that surrounds the open portion 155. The bellows tongue 115, best illustrated in FIG. 7, is substantially oval-shaped with a long axis extending substantially parallel to the central axis 80. The tongue 115 extends around the outermost perimeter of the bellows 45 with the lowermost portion of the oval engaged with the bellows groove 110 and surface 121 to establish a seal that inhibits fluid communication between the pump-side interior 145 and the atmosphere-side interior 150 when the breather assembly 10 is fully assembled.

The bellows 45 and the interior 70 are sized to provide enough volume to compensate for at least a portion of the expected pressure changes within the piston housing 30. However, the bellows 45 and the interior 70 are generally not so large as to compensate for all of the possible pressure change. For example, one piston housing 30 may experience pressure fluctuations of 5 pounds per square inch (psi) above and below atmospheric pressure during operation. A suitable bellows 45 and interior 70 may be sized to accommodate sixty percent (3 psi) of these pressure changes, thus still allowing some pressure change within the piston housing to facilitate lubrication of the moving parts.

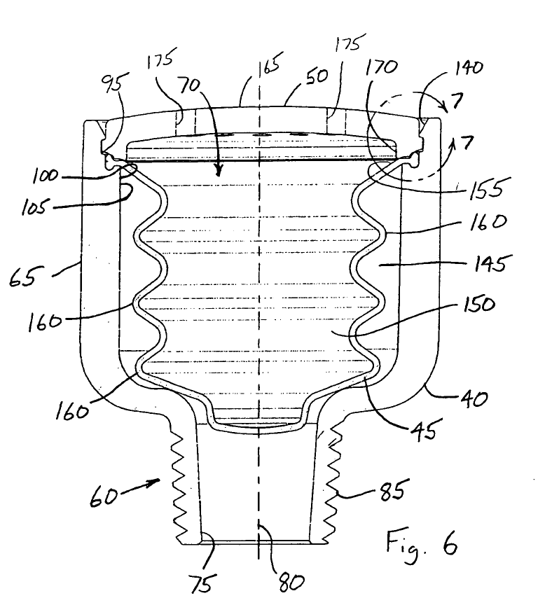

The cover 50, illustrated in FIGS. 5-7, includes a plate portion 165 and a leg portion 170 that extends around the perimeter of the plate portion 165. The plate portion 165 can be substantially planar, or, as illustrated in FIG. 6, can have a slight curve or dish-shape. A plurality of apertures 175, illustrated in FIGS. 5 and 6, extend through the plate portion 165 and provide fluid communication between the atmosphere and the atmosphere-side interior 150. While a plurality of circular apertures 175 are illustrated, a variety of aperture shapes, sizes, and quantities can be employed, so long as the total flow area defined by the apertures is sufficient to allow the desired volume of air flow at the desired rate.

The leg portion 170 extends substantially normal to the plate portion 165 and defines the cover lip 130 and a bellows clamp surface 180. The cover lip 130 extends radially outward and is sized to engage the cover slot 125 to couple the cover 50 to the base 40. The bellows clamp surface 180, best illustrated in FIG. 7, includes an arcuate portion 185 that extends downward (i.e., toward the attachment portion) and radially inward from the cover lip 130 to a planar portion 190 that is substantially normal to the central axis 80. The bellows clamp surface 180 cooperates with the bellows groove 110 to define a bellows-receiving space 195. However, the bellows-receiving space 195 is smaller than the bellows tongue 115 when the cover 50 is positioned as illustrated in FIG. 7. As such, the bellows tongue 115 is compressed when the components are assembled. The arcuate portion 185 is arranged to compress the oval radially outward and downward into the bellows groove 110. The planar portion 190 also compresses the bellows 45 downward to achieve a substantially airtight seal. FIG. 7 illustrates the cover 50 in its operating position and the bellows 45 in an uncompressed condition to better illustrate a compression zone 200 (double cross-hatched portion). As illustrated, the compression zone 200 interferes with the bellows clamp surface 180. Thus, it is the compression zone 200 of the bellows 45 that is compressed during assembly to achieve the desired airtight seal.

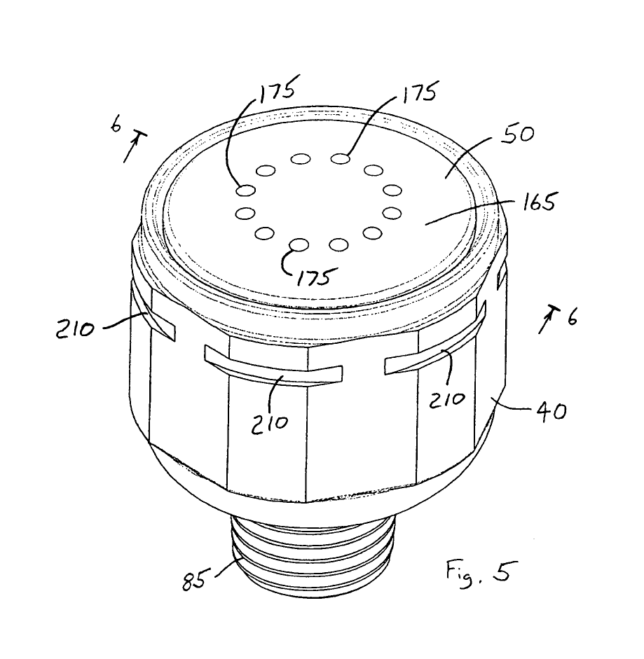

FIGS. 3 and 4 illustrate the cap 55 that fits over the cover 50. The cap includes a plurality of engagement tabs 205 that extend radially inward and engage several cap grooves 210 (shown in FIG. 5) that are formed in the exterior of the body portion 65. In the illustrated construction, a plurality of grooves 210 and tabs 205 are employed. In other constructions, a single continuous tab engages a single continuous slot. In still other constructions, other attachment means (e.g., adhesive, threads, etc.) are employed to attach the cap 55 to the cover 50. In addition, other constructions may reverse the location of the tabs 205 and grooves 210 such that slots are formed in the cap 55.

The cap 55 does not seal the apertures 175 but rather allows for the substantially free flow of air into and out of the interior 70. The cap 55 also inhibits clogging or plugging of the apertures 175 in the cover 50.

To manufacture the breather assembly 10, the individual components are first formed. The base 40 can be formed from metal, plastic, ceramic, composite, or other material suitable for use in the operating environment of the breather assembly 10. In preferred constructions, the base 40 is injection molded from a plastic material. Similarly, the cover 50 can be manufactured using any suitable material with injection-molded plastic being preferred. The cap 55 is also generally formed from an injection-molded plastic, with other materials and manufacturing processes also being suitable for use. The bellows 45 is generally formed from a rubber material (e.g., synthetic, or natural) or another resilient, flexible material that is suited to use in the environment of the breather assembly 10.

The bellows 45 is inserted into the interior 70 of the base 40 such that the bellows tongue 115 rests within the bellows groove 110. The cover 50 is positioned above the second aperture 105 of the base 40 such that the cover lip 130 rests on the tapered surface 140 of the base 40. The cover 50 is then pushed downward until the cover lip 130 engages the cover slot 125. The tapered surface 140 serves to guide the cover 50 into its operating position. As the cover 50 is pushed downward, the bellows tongue 115 is compressed and a seal between the pump-side interior 145 and the atmosphere-side interior 150 is established. The cap 55 is then positioned over the cover 50 and is pushed downward until the engagement tabs 205 engage the cap grooves 210.

When positioned for operation, the breather assembly 10 is in fluid communication with the chamber 35 of the piston housing 30 as illustrated in FIG. 2. It is desirable to maintain the pressure within the piston housing 30 at a pressure that is substantially within a range near atmospheric pressure (e.g., between 5 psi absolute and 25 psi absolute). However, during operation, the pressure within the piston housing 30 may vary (e.g., due to heating, cooling, movement of the various components, etc.). The breather assembly 10 compensates for these pressure changes without discharging oil-laden air from within the piston housing 30 and without drawing air into the piston housing 30. For example, during pump start-up, the temperature of the various components may increase. The increased component temperature will increase the air temperature within the piston housing 30. Without the breather assembly 10, the increased temperature would produce an increased pressure within the piston housing 30. However, the breather assembly 10 allows the volume of the piston housing 30 to vary, thus reducing the magnitude of the pressure changes within the piston housing 30. As the air temperature increases, the air expands into the pump-side interior 145 of the breather assembly 10. If the pressure within the pump-side interior 145 increases beyond the pressure of the air within the atmosphere-side interior 150, the bellows 45 will move upward to reduce the volume of the atmosphere-side interior 150 and increase the volume of the pump-side interior 145. The reduced volume of the atmosphere-side interior 150 forces air within the atmosphere-side interior 150 to be discharged from the breather assembly 10. When the pump cools, the opposite occurs; the air within the chamber 35 cools and the pressure falls below atmospheric pressure. Atmospheric air flows through the apertures 175 in the cover 50 and into the atmosphere-side interior 150. The additional air flowing into the atmosphere-side interior 150 moves the bellows 45 downward to reduce the volume of the pump-side interior 145 and thus reduce the volume accessible by the air within the chamber 35.

A pump employing the breather assembly 10 described herein can be shipped with lubricant in the piston housing and the breather assembly 10 installed in an operating position. Because the breather assembly 10 does not allow for the passage of fluid into or out of the piston housing, the pump can be shipped without fear of spilling oil from the breather assembly. In addition, the user does not need to remove a shipping plug and install the breather assembly before use.

Thus, the invention provides, among other things, a breather that maintains the pressure within an enclosed chamber without discharging air or drawing in air by varying the volume of the chamber. Various features and advantages of the invention are set forth in the following claims.

What is claimed is:

1. A breather assembly for a crankcase including a chamber having a chamber pressure, the breather assembly comprising:
a base coupled to the crankcase and including an interior, the base defining a first aperture to allow fluid communication between the chamber and the interior, and a second aperture to allow fluid communication between an atmosphere and the interior; and
a movable membrane disposed substantially within the interior to define a crankcase-side of the interior and an atmosphere-side of the interior.

2. The breather assembly of claim 1, wherein the membrane is movable to increase the volume of the crankcase-side of the interior in response to an increase in the chamber pressure, and wherein the membrane is movable to decrease the volume of the crankcase-side of the interior in response to a decrease in the chamber pressure.

3. The breather assembly of claim 1, wherein the base further includes a seal portion and a clamp surface that engage the membrane to maintain a substantially fluid tight seal between the crankcase-side of the interior and the atmosphere-side of the interior.

4. The breather assembly of claim 1, further comprising a cap coupled to the base to cover the second aperture.

5. The breather assembly of claim 4, wherein one of the cap and base includes at least one tab that extends inward, and the other of the cap and base defines at least one groove positioned to engage the at least one tab to couple the cap to the base.

6. The breather assembly of claim 1, wherein the base further includes an attachment portion having a quick disconnect to attach the breather assembly to the crankcase.

7. The breather assembly of claim 1, wherein the second aperture includes a plurality of apertures.

8. The breather assembly of claim 1, wherein the membrane includes a single piece bellows that defines a membrane interior and a membrane exterior and includes a plurality of pleats.

9. The breather assembly of claim 8, wherein the membrane interior at least partially defines the atmosphere-side interior.

10. The breather assembly of claim 1, wherein the membrane includes a resilient material.

11. A breather assembly for a crankcase including a chamber having a chamber pressure, the breather assembly comprising:
a base coupled to the crankcase and including an interior, the base defining a first aperture to allow fluid communication between the crankcase and the interior;
a cover coupled to the base and including a second aperture that provides fluid communication between an atmosphere and the interior; and
a movable membrane disposed substantially within the interior to define a crankcase-side of the interior and an atmosphere-side of the interior.

12. The breather assembly of claim 11, wherein the membrane is movable to increase a volume of the crankcase-side in response to an increase in the chamber pressure, and wherein the membrane is movable to decrease a volume of the crankcase-side in response to a decrease in the chamber pressure.

13. The breather assembly of claim 11, wherein a portion of the membrane is sandwiched between the base and the cover to define a substantially fluid tight seal between the crankcase-side and the atmosphere-side.

14. The breather assembly of claim 13, wherein the base further includes a seal portion and the cover portion includes a clamp surface, and wherein the seal portion and the clamp surface cooperate to at least partially deform the portion of the membrane sandwiched therebetween.

15. The breather assembly of claim 11, further comprising a cap coupled to the base to cover the second aperture.

16. The breather assembly of claim 15, wherein one of the cap and base includes at least one tab that extends inward, and the other of the cap and base defines at least one groove positioned to engage the at least one tab to couple the cap to the base.

17. The breather assembly of claim 15, wherein the cap and the base cooperate to define an annular aperture that provides fluid communication between the atmosphere and the second aperture.

18. The breather assembly of claim 11, wherein the base further includes an attachment portion having a quick disconnect to attach the breather assembly to the crankcase.

19. The breather assembly of claim 11, wherein the membrane includes a single piece bellows that defines a membrane interior and a membrane exterior and includes a plurality of pleats.

20. The breather assembly of claim 19, wherein the membrane interior at least partially defines the atmosphere-side interior.

21. The breather assembly of claim 11, wherein the membrane includes a resilient material.
